(19) United States
(12) Patent Application Publication
(10) Pub. No.: US 2016/0064791 A1
(43) Pub. Date: Mar. 3, 2016

(54) IMPEDANCE CONVERTER

(71) Applicant: KABUSHIKI KAISHA TOSHIBA, Minato-ku (JP)

(72) Inventors: Satoshi ONO, Yokohama (JP); Takaya KITAHARA, Kamakura (JP); Shigeru HIURA, Tokyo (JP)

(73) Assignee: KABUSHIKI KAISHA TOSHIBA, Minato-ku (JP)

(21) Appl. No.: 14/843,403

(22) Filed: Sep. 2, 2015

(30) Foreign Application Priority Data
Sep. 2, 2014 (JP) 2014-178328

(51) Int. Cl. H01P 1/212; H01P 5/02

(52) U.S. Cl. CPC H01P 1/212; H01P 5/02

(57) ABSTRACT

According to one embodiment, an impedance converter includes a plurality of disposed characteristic impedance elements and at least one stub. The disposed characteristic impedance elements each has an electric length corresponding to a particular frequency. The at least one stub is formed on a characteristic impedance element formed on a signal input side among the plurality of characteristic impedance elements, and has an impedance value which suppresses passage of a signal having a predetermined multiple of a fundamental frequency.

### CROSS-REFERENCE TO RELATED APPLICATIONS

This application is based upon and claims the benefit of priority from Japanese Patent Application No. 2014-178328, filed Sep. 2, 2014, the entire contents of which are incorporated herein by reference.

### FIELD

Embodiments described herein relate to an impedance converter in which a plurality of characteristic impedance elements, each of which has an electric length corresponding to a particular frequency, are disposed.

### BACKGROUND

For high-frequency circuits, an impedance converter is used to perform impedance matching and reduce attenuation of a high-frequency signal. This impedance converter needs to maintain frequency characteristics of the fundamental frequency f₀ of the high-frequency signal.

When a high-frequency signal of the fundamental frequency f₀ is subjected to impedance conversion at the impedance converter, harmonic signals of odd frequency multiples of the fundamental frequency f₀, such as threefold, fivefold, and sevenfold frequencies 3·f₀, 5·f₀, and 7·f₀, are also subjected to impedance conversion, and are allowed to pass through the impedance converter. If the harmonic signals of odd frequency multiples pass through the impedance converter, the harmonic signals influence the high-frequency signal of the fundamental frequency f₀ and, for example, distort the high-frequency signal of the fundamental frequency f₀.

### BRIEF DESCRIPTION OF THE DRAWINGS

FIG. 1 shows a configuration of a microstrip line model four-stage λ/4 length impedance converter according to an embodiment.

FIGS. 2A, 2B, and 2C show a specific configuration of the impedance converter according to the embodiment.

FIG. 3 shows gain-frequency characteristics of the impedance converter according to the embodiment.

FIG. 4 shows gain-frequency characteristics of an impedance converter in which a stub is not formed for comparison with the impedance converter according to the embodiment.

FIG. 5 shows gain-frequency characteristics of the impedance converter according to the embodiment in the case where the characteristic impedance of the stub is three times the impedance of a characteristic impedance element.

FIG. 6 shows gain-frequency characteristics of the impedance converter according to the embodiment in the case where the characteristic impedance of the stub is four times the impedance of the characteristic impedance element.

FIG. 7 shows gain-frequency characteristics of the impedance converter according to the embodiment in the case where the characteristic impedance of the stub is five times the impedance of the characteristic impedance element.

FIG. 8 shows gain-frequency characteristics of the impedance converter according to the embodiment in the case where the characteristic impedance of the stub is six times the impedance of the characteristic impedance element.

FIG. 9 illustrates improvement in frequency characteristics of the case where the line length of each stub is set in the impedance converter according to the embodiment.

FIG. 10 shows gain-frequency characteristics before improvement in frequency characteristics by the line length of each stub in the impedance converter according to the embodiment.

FIG. 11 shows gain-frequency characteristics of the impedance converter according to the embodiment in the case where the characteristic impedance of one stub is five times the impedance of the characteristic impedance element.

FIG. 12 shows gain-frequency characteristics of the impedance converter according to the embodiment in the case where the characteristic impedance of one stub is ten times the impedance of the characteristic impedance element.

FIG. 13 shows gain-frequency characteristics of the impedance converter according to the embodiment in the case where the characteristic impedance of one stub is twenty times the impedance of the characteristic impedance element.

FIG. 14 shows a configuration of the impedance converter according to the embodiment, in which four stubs are formed.

FIG. 15 shows gain-frequency characteristics of the impedance converter according to the embodiment.

### DETAILED DESCRIPTION

Hereinafter, an impedance converter according to the present embodiment will be described in detail with reference to the drawings. In the following embodiment, the elements which perform the same operations will be assigned the same reference numerals, and redundant explanations will be omitted.

An impedance converter is required to maintain frequency characteristics of a high-frequency signal of the fundamental frequency f₀, and to reflect and attenuate harmonic signals of odd frequency multiples of the fundamental frequency f₀.

According to one embodiment, an impedance converter includes a plurality of disposed characteristic impedance elements and at least one stub. The disposed characteristic impedance elements each has an electric length corresponding to a particular frequency. The at least one stub is formed on a characteristic impedance element formed on a signal input side among the plurality of characteristic impedance elements, and has an impedance value which suppresses passage of a signal having a predetermined multiple of a fundamental frequency.

Hereinafter, an embodiment will be described with reference to the drawings.

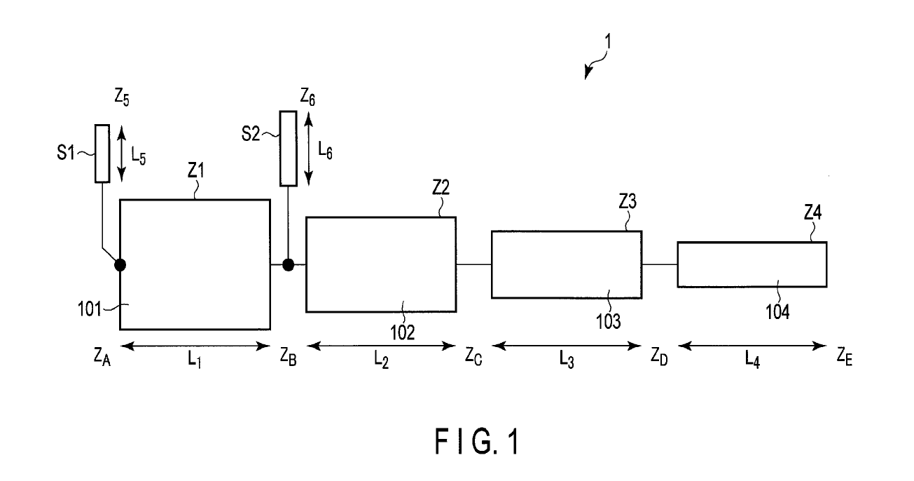

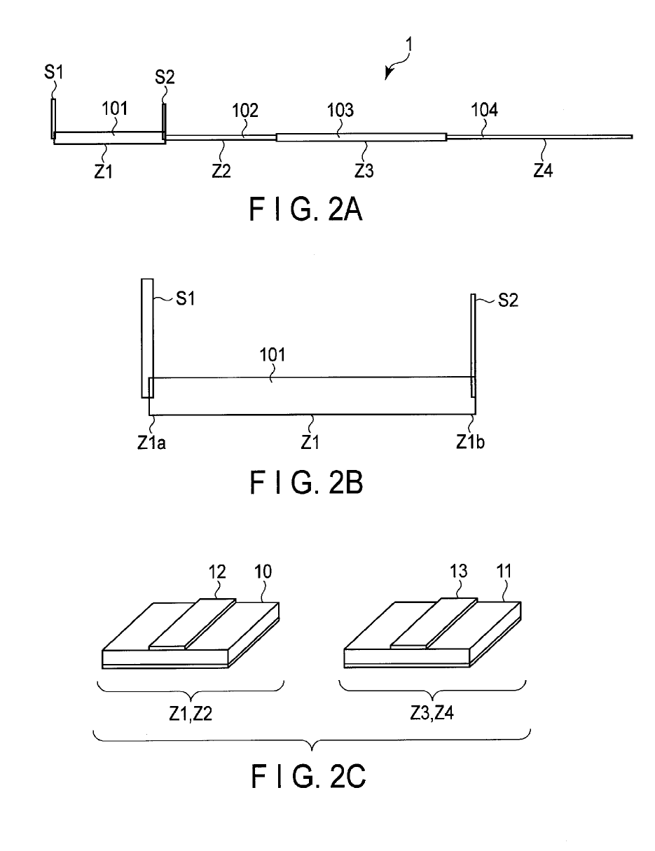

FIG. 1 shows a configuration of a microstrip line model four-stage λ/4 length impedance converter (hereinafter referred to as “impedance converter”) 1, and FIGS. 2A, 2B, and 2C show a specific configuration of the impedance converter of FIG. 1.

The impedance converter 1 has an electric length corresponding to a particular frequency as shown in FIGS. 1 and 2A, and is configured as a transmission line in which multiple stages of characteristic impedance elements, four stages (having impedance values Z₁-Z₄) herein, are connected in series.

Through the impedance converter 1, for example, a high-frequency signal in an ultra high frequency (UHF) band passes as a high-frequency signal. The high-frequency signal is input to characteristic impedance element 101, passes through characteristic impedance elements 102 and 103, and is output from characteristic impedance element 104. Accordingly, characteristic impedance element 101 is the signal input side, and characteristic impedance element 104 is the signal output side.

Impedance values Z₁, Z₂, Z₃, and Z₄ of the characteristic impedance elements of the transmission line have the following magnitude relationship:

Z₁≦Z₂≦Z₃≦Z₄ (1)

Z_{A}, Z_{B}, Z_{C}, Z_{D}, and Z_{E} represent impedance values at certain points in the impedance converter 1. Impedance value Z_{A} represents an impedance value on a low impedance side of characteristic impedance element 101. Impedance value Z_{B} represents an impedance value on a high impedance side of characteristic impedance element 101. Similarly, impedance value Z_{C} represents an impedance value on a low impedance side of characteristic impedance element 102, and impedance value Z_{D} represents an impedance value on a high impedance side of characteristic impedance element 103. Impedance value Z_{E} represents an impedance value on a high impedance side of characteristic impedance element 104.

L₁, L₂, L₃, and L₄ represent line lengths of the characteristic impedance elements 101, 102, 103, and 104, respectively. L₁ is a line length of characteristic impedance element 101, L₂ is a line length of characteristic impedance element 102, L₃ is a line length of characteristic impedance element 103, and L₄ is a line length of characteristic impedance element 104. The line lengths L₁, L₂, L₃, and L₄ of the characteristic impedance elements 101, 102, 103, and 104 are nearly equal to a quarter wavelength (A/4) of fundamental frequency f₀.

L₁,L₂,L₃,L₄L≈λ/4 at f₀ (2)

A specific example of the impedance conversion of the impedance converter 1 will be described. When the impedance converter 1 is ideal, impedance conversion from, for example, an input impedance value to an output impedance value (50Ω) is performed. Actually, the impedance converter 1 converts an impedance value 2.08Ω into 48.5Ω.

Specifically, at the first-stage characteristic impedance element 101, impedance value Z_{A}(=approximately 2.08Ω) on the input side is converted into impedance value Z_{B}(4.22Ω) on the output side.

At the second-stage characteristic impedance element 102, impedance value Z_{B}(4.22Ω) on the input side is converted into impedance value Z_{C}(12.9Ω) on the output side.

At the third-stage characteristic impedance element 103, impedance value Z_{C}(12.9Ω) on the input side is converted into impedance value Z_{D}(34.1Ω) on the output side.

At the fourth-stage characteristic impedance element 104, impedance value Z_{D}(34.1Ω) on the input side is converted into impedance value Z_{E}(48.5Ω) on the output side.

The impedance converted values of the characteristic impedance elements 101, 102, 103, and 104 of respective stages are mere examples, and may be other impedance values.

In the impedance converter 1, a plurality of stubs, for example, two stubs including a first stub S₁ and a second stub S₂, are formed on characteristic impedance element 101 disposed on the signal input side among the plurality of characteristic impedance elements 101, 102, 103, and 104.

The first and second stubs S₁ and S₂ have impedance values Z₅ and Z₆ which suppress passage of a high-frequency signal having a predetermined frequency multiple of the fundamental frequency f₀, such as a threefold frequency 3·f₀, which is an odd frequency multiple.

The points where the stubs S₁ and S₂ are formed, i.e., points on the transmission line in which the characteristic impedance elements 101-104 are connected in series, are points where the impedance value is 4Ω or smaller on the transmission line. This impedance value (4Ω or smaller) is an impedance value for maintaining the characteristics of the high-frequency signal of the fundamental frequency f₀.

Specifically, the first stub S₁ is formed at an end portion Z₁ₐ on the signal input side (low impedance Zₐ side) of the first-stage characteristic impedance element 101, for example, at a point where the impedance value is 2.08Ω. The stub S₁ is formed to partly overlap characteristic impedance element 101 at the end portion Z₁ₐ on the signal input side, as shown in FIG. 2B.

The second stub S₂ is formed at a point where the impedance value is 4Ω or smaller between characteristic impedance elements 101 and 102 including an end portion Z_{1b} on the signal output side (high impedance Z_{B} side) of the first-stage characteristic impedance element 101. Since the impedance value Z_{B} on the output side of the first-stage characteristic impedance element 101 is 4.22Ω as described above, the second stub S₂ is formed at, for example, an end portion Z_{1b} of characteristic impedance element 101 as a point where the impedance value is 4Ω or smaller. Like the first stub S₁, the second stub S₂ is formed to partly overlap characteristic impedance element 101 at the end portion Z_{1b} on the signal input side, as shown in FIG. 2B.

The second stub S₂ is not necessarily on the high impedance side (Z_{B} side) of characteristic impedance element 101, and may be at any point where the impedance value is 4Ω or less, for example, on a transmission line between characteristic impedance elements 101 and 102 or on characteristic impedance element 101 or 102 where the impedance value is 4Ω or less.

The characteristic impedances Z₅ and Z₆ of the stubs S₁ and S₂ are five or more times larger than the impedance value of characteristic impedance element 101 on which the stubs S₁ and S₂ are formed. Based on expression (1), the impedance values of the stubs S₁ and S₂ and those of the characteristic impedance elements 101, 102, 103, and 104 have the following magnitude relationship:

Z₁≦Z₂≦Z₃≦Z₄≦Z₅≦Z₆ (3)

The line lengths L₅ and L₆ of the stubs S₁ and S₂ are each set based on a high-frequency signal having a threefold frequency 3·f₀ of the fundamental frequency f₀ and a particular frequency, such as frequency 3·f₀. The line lengths L₅ and L₆ of the stubs S₁ and S₂ can be obtained based on the following expression:

L₅,L₆≈λ/4 at 3·f₀ (4)

Line length L₆ of the stub S₂ is longer than line length L₅ of the stub S₁. Namely, the line lengths L₅ and L₆ of the stubs S₁ and S₂ have the following relationship:

L₅≦L₆

The characteristic impedances Z₅ and Z₆ of the lines of the stubs S₁ and S₂ that suppress passage of a high-frequency signal at a threefold frequency 3·f₀ of the fundamental frequency f₀ are determined by a reflection coefficient Γ that satisfies the following expressions (5) and (6) at the fundamental frequency:

Γ=(Z_{c-3rd}−Z_{f0})/Z_{c-3rd}+Z_{f0}) (5)

Γ≧0.67 (6)

, where Z_{c-3rd} is an impedance value of the stubs S₁ and S₂ at Z₁ₐ and Z_{1b}, and Z_{f0} is an impedance value Z_{A} and Z_{B} of the fundamental wave.

The stubs S₁ and S₂ may have lengths L₅ and L₆ corresponding to different predetermined frequency multiples, such as threefold and fivefold frequencies.

The first stub S₁ is formed on the low impedance side (Z_{A} side) of characteristic impedance element 101, and has line length L₅ which suppresses passage of a high-frequency signal having a threefold frequency 3·f₀ of the fundamental frequency.

The second stub S₂ is formed on the high impedance side (Z_{B} side) of characteristic impedance element 101, and has line length L₆ which suppresses passage of a low-frequency signal included in the high-frequency signal having a threefold frequency 3·f₀ of the fundamental frequency.

When the impedance converter 1 is used for impedance conversion at, for example, a high-frequency amplifier circuit using a wide band Doherty amplifier, the impedance converter 1 of the wide band Doherty amplifier is configured on the assumption that two substrates 10 and 11 are used as shown in, for example, FIG. 2C.

Of the substrates 10 and 11, one substrate 10 constitutes characteristic impedance elements 101 and 102 on the low impedance side. On the substrate 10, stripline 12 of characteristic impedance elements 101 and 102 is formed. Stripline 12 is made of, for example, copper.

The other substrate 11 constitutes characteristic impedance elements 103 and 104 on the high impedance side. On substrate 11, stripline 13 of characteristic impedance elements 103 and 104 is formed. Stripline 13 is made of, for example, copper foil.

The dielectric constant of substrate 10 is higher than that of substrate 11. Substrate 10 is thicker than substrate 11.

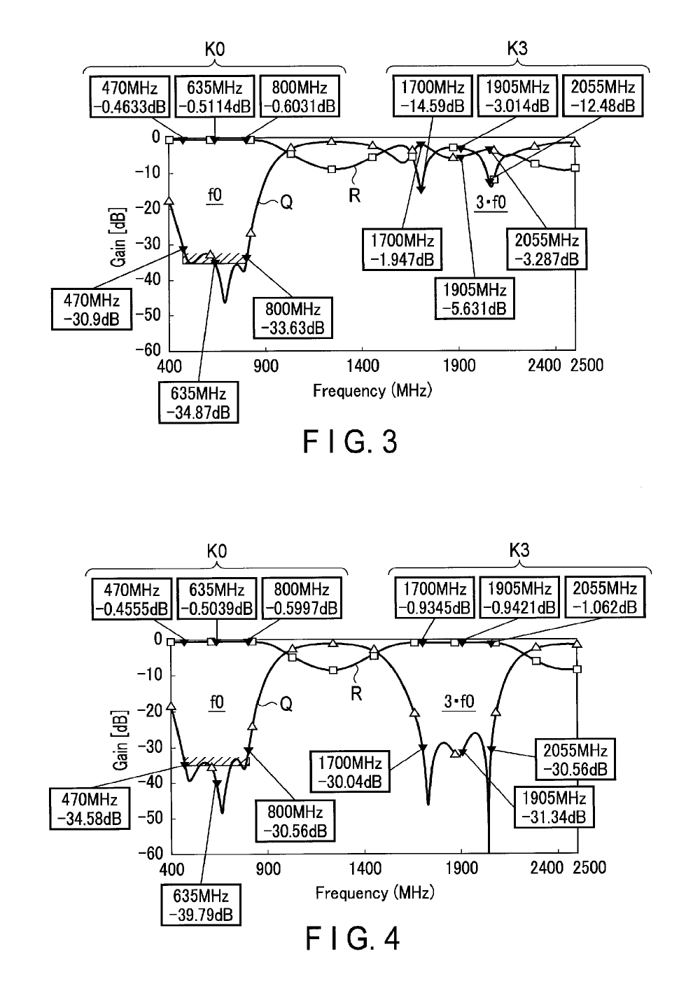

Since the impedance converter 1 is provided with the first stub S₁ formed on the lower impedance side (Z_{A} side) of characteristic impedance element 101, and having line length L₅ which suppresses passage of a high-frequency signal having a threefold frequency 3·f₀ of the fundamental frequency and the second stub S₂ formed on the high impedance side (Z_{B} side) of characteristic impedance element 101, and having line length L₅ which suppresses passage of a low-frequency signal included in the high-frequency signal having a threefold frequency 3·f₀ of the fundamental frequency, the impedance converter 1 has gain-frequency characteristics shown in FIG. 3, for example. In FIG. 3, Q indicates reflection characteristics, and R indicates transmission characteristics. In the frequency band K₀ of the fundamental frequency that includes the fundamental frequency f₀, for example, frequency band K₀ that includes 470 MHz, 635 MHz, and 800 MHz, the reflection characteristics Q are low, for example, equal to or lower than −30 dB, and the transmission characteristics R are high. When the reflection characteristics are equal to or lower than −30 dB, the frequency characteristics in the frequency band K₀ that includes the fundamental frequency f₀, can be maintained. Thus, in the frequency band K₀ that includes the fundamental frequency f₀, the frequency characteristics of a high-frequency signal of the fundamental frequency f₀ can be maintained.

In contrast, in the frequency band K₃ that includes a threefold frequency 3·f₀ of the fundamental frequency f₀, the reflection characteristics Q are higher and the transmission characteristics R are lower than in the frequency band K₀ that includes the fundamental frequency f₀. The frequency band K₃ includes the threefold frequency 3·f₀, for example, 1700 MHz, 1905 MHz, and 2055 MHz. This shows that, in the frequency band K₃ that includes the threefold frequency 3·f₀, a high-frequency signal in the frequency band K₃ that includes the threefold frequency 3·f₀ is reflected and attenuated.

FIG. 4 shows gain-frequency characteristics of an impedance converter in which stubs S₁ and S₂ are not formed. The reflection characteristics Q of the impedance converter are low, and the transmission characteristics R of the impedance converter are high in the frequency band K₃ that includes the threefold frequency 3·f₀. This shows that, in the frequency band K₃, a high-frequency signal in the frequency band K₃ that includes the threefold frequency 3·f₀ passes without being reflected and attenuated.

Accordingly, the impedance converter 1 of the present embodiment shown in FIG. 3 has much lower reflection characteristics and much higher transmission characteristics R at the threefold frequency 3·f₀ than the impedance converter which is not provided with stubs S₁ and S₂ of the present embodiment shown in FIG. 4.

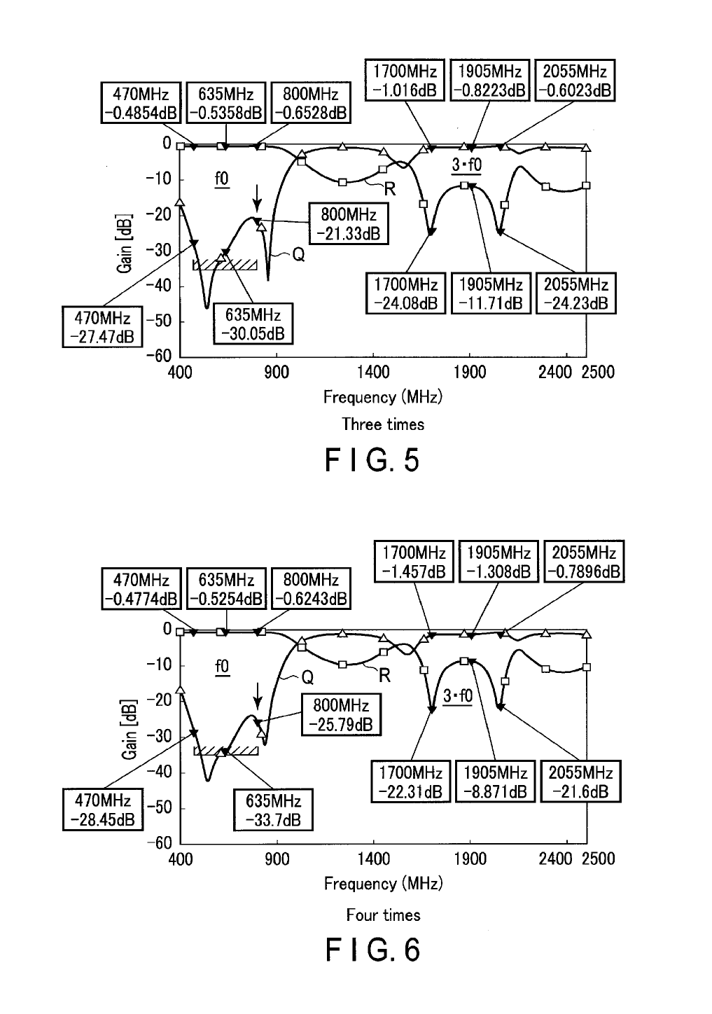

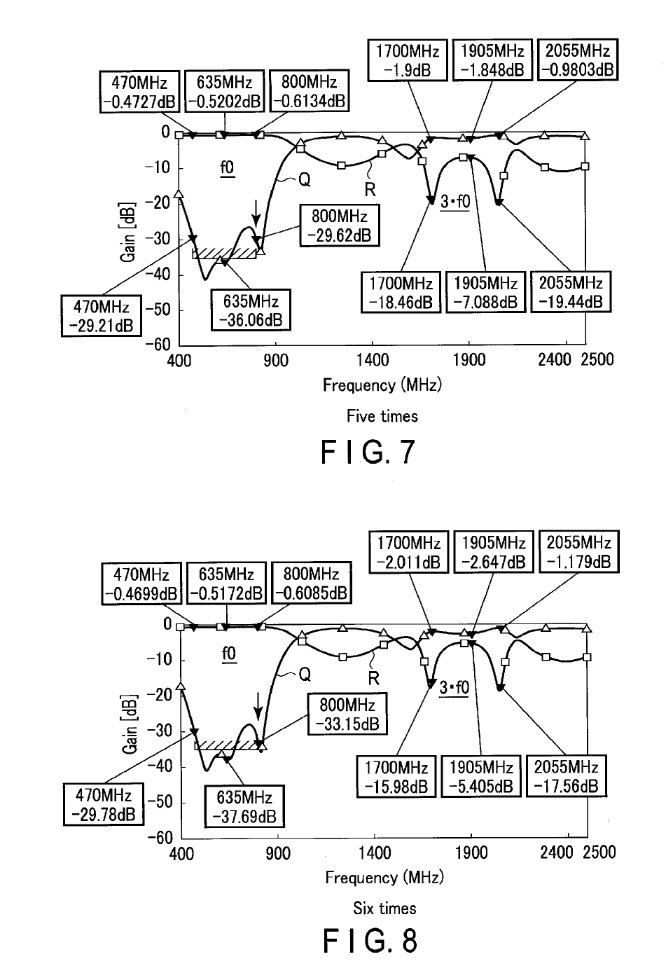

In addition, the characteristic impedances Z₅ and Z₆ of the stubs S₁ and S₂ are five or more times larger than the impedance value of characteristic impedance element 101 on which the stubs S₁ and S₂ are formed, and Since the reflection coefficient Γ satisfies Γ≧0.67, as shown in expressions (5) and (6), degradation in the reflection characteristics Q in the frequency band K₀ that includes the fundamental frequency f₀ can be suppressed. FIG. 5 shows gain-frequency characteristics of the case where the characteristic impedances Z₅ and Z₆ of the stubs S₁ and S₂ are three times larger than the impedance value of characteristic impedance element 101. FIG. 6 shows gain-frequency characteristics of the case where the characteristic impedances Z₅ and Z₆ of the stubs S₁ and S₂ are four times larger than the impedance value of characteristic impedance element 101. FIG. 7 shows gain-frequency characteristics of the case where the characteristic impedances Z₅ and Z₆ of the stubs S₁ and S₂ are five times larger than the impedance value of characteristic impedance element 101. FIG. 8 shows gain-frequency characteristics of the case where the characteristic impedances Z₅ and Z₆ of the stubs S₁ and S₂ are six times larger than the impedance value of characteristic impedance element 101. In FIGS. 5-8, if a frequency of 800 MHz (indicated by a downward arrow 1) in the frequency band K₀ that includes the fundamental frequency f₀ is noted, it can be understood that the gain of the reflection characteristic Q is, for example, equal to or lower than −30 dB in the case of the fivefold impedance value shown in FIG. 7.

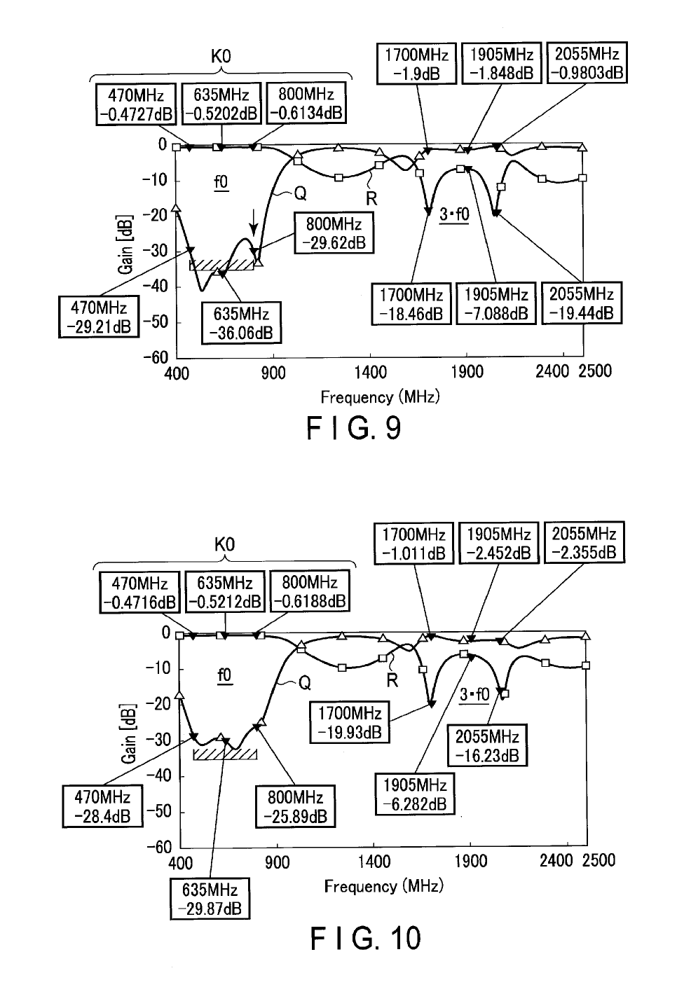

Since the impedance converter 1 is provided with the first stub S₁ formed on the lower impedance side (Z_{A} side) of characteristic impedance element 101, and having line length L₅ which suppresses passage of a high-frequency signal having a threefold frequency 3·f₀ of the fundamental frequency and the second stub S₂ formed on the high impedance side (Z_{B} side) of characteristic impedance element 101, and having line length L₆ (≧L₅) which suppresses passage of a low-frequency signal included in the high-frequency signal having a threefold frequency of the fundamental frequency, the setting of the line lengths L₅ and L₆ can also improve frequency characteristics in the frequency band K₀ including the fundamental frequency f₀. For example, as shown in FIG. 9, the gain at a frequency of 800 MHz (indicated by a downward arrow ↓) in the frequency band K₀ is −29.62 dB, which is almost −30 dB.

In contrast, if the line length of the second stub S₂ is not L₆ (≧L₅), the gain at the frequency of 800 MHz is −25.89 dB as shown in FIG. 10, for example. It can be understood that frequency characteristics in the frequency band K₀ including the fundamental frequency f₀ can be improved by allowing the second stub S₂ to have line length L₆ (L₅) as described in the present embodiment.

In the above embodiment, the case where two stubs S₁ and S₂ are provided is described. However, the number of the stubs is not limited to two, and for example, only one stub S₁ may be formed.

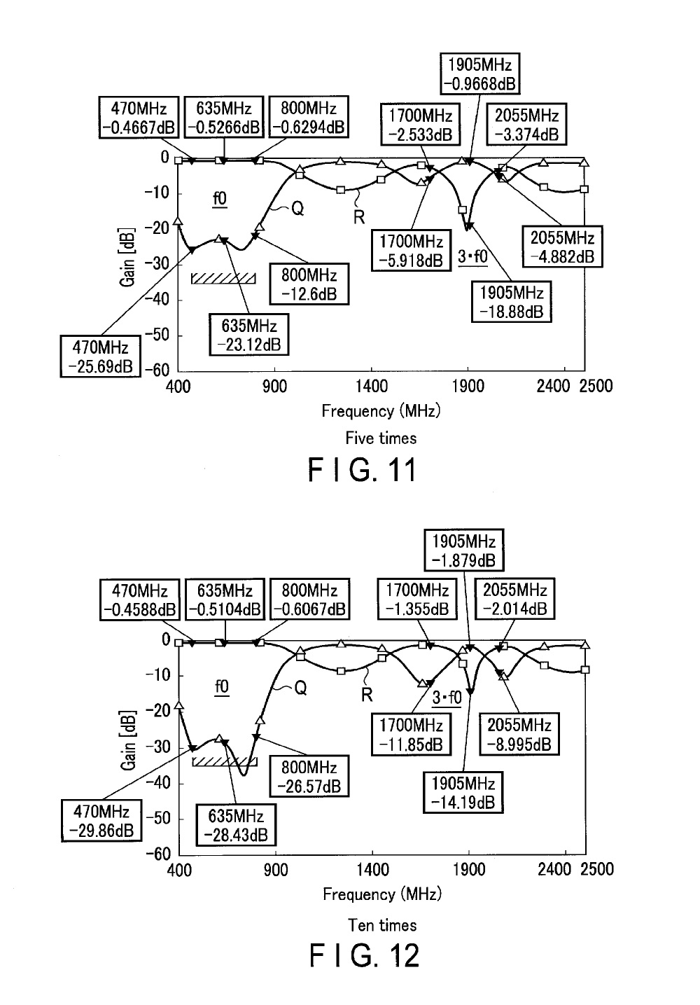

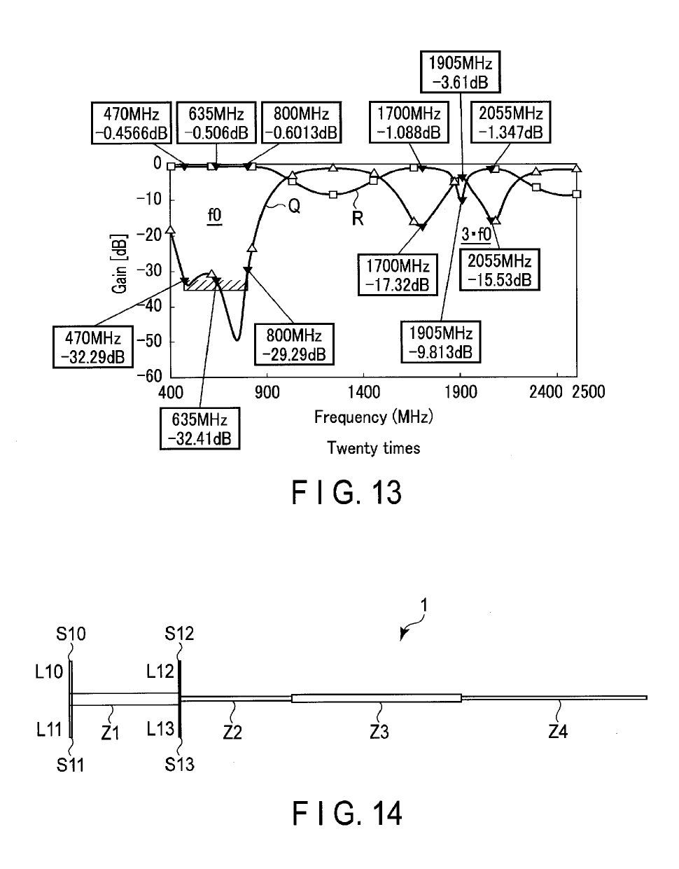

FIG. 11 shows gain-frequency characteristics of the case where, for example, one stub S₁ is formed, and the characteristic impedance Z₅ of the stub S₁ is five times larger than the impedance value of characteristic impedance element 101. FIG. 12 shows gain-frequency characteristics of the case where one stub S₁ is formed, and the characteristic impedance Z₅ of the stub S₁ is ten times larger than the impedance value of characteristic impedance element 101. FIG. 13 shows gain-frequency characteristics of the case where one stub S₁ is formed, and the characteristic impedance Z₅ of the stub S₁ is twenty times larger than the impedance value of characteristic impedance element 101.

Accordingly, if one stub S₁ is provided, the reflection characteristics Q are low and the transmission characteristics R are high at a frequency corresponding to the line length L₅ of the stub S₁, for example, 1905 MHz in the frequency band K₃ that includes the threefold frequency 3·f₀.

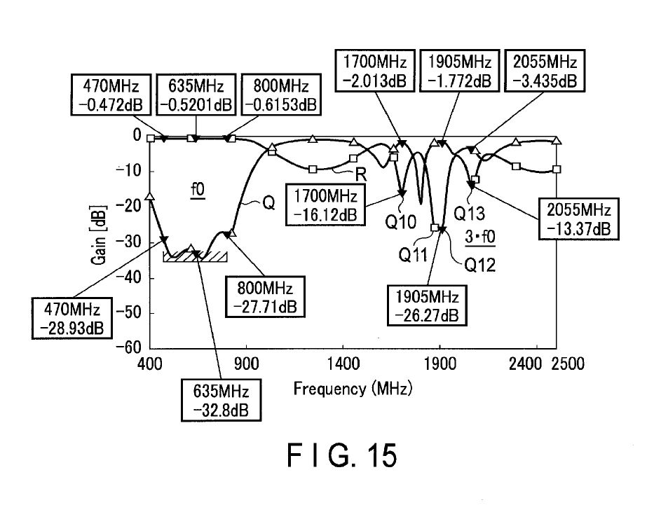

FIG. 14 shows a configuration of the impedance converter 1 in which four stubs S₁₀, S₁₁, S₁₂, and S₁₃ are formed. FIG. 15 shows gain-frequency characteristics of the impedance converter 1. The stubs S₁₀, S₁₁, S₁₂, and S₁₃ each have an impedance value equal to or smaller than 5Ω after conversion, and have a characteristic impedance value three times larger than the impedance value of characteristic impedance element 101. Stub S₁₀ has a length L₁₀ that is obtained based on expression (7), below. Similarly, stubs S₁₁, S₁₂, and S₁₃ have lengths L₁₁, L₁₂ and L₁₃ that are obtained based on the formula (7).

L₁₀,L₁₁,L₁₂, and L₁₃≈λ/4 at 3·f₀ (7)

The line lengths L₁₀, L₁₁, L₁₂, and L₁₃ correspond to frequencies in the frequency band K₃ including the threefold frequency 3·f₀ in which a high-frequency signal is attenuated.

As shown in FIG. 15, line length L₁₀ corresponds to a frequency of 1700 MHz, line length L₁₁ corresponds to a frequency of 1905 MHz, line length L₁₂ corresponds to a frequency of 1700 MHz, line length L₁₃ corresponds to a frequency of 2055 MHz.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An impedance converter, comprising:
a plurality of disposed characteristic impedance elements, each having an electric length corresponding to a particular frequency; and
at least one stub formed on a characteristic impedance element formed on a signal input side among the characteristic impedance elements, and having an impedance value which suppresses passage of a signal having a predetermined multiple of a fundamental frequency.

2. The impedance converter according to claim 1, wherein
an impedance value of the characteristic impedance on which the stub is formed is equal to or smaller than an impedance value for maintaining characteristics of the fundamental frequency.

3. The impedance converter according to claim 1, wherein
a length of the stub is set based on the signal having the predetermined multiple of the fundamental frequency and the particular frequency.

4. The impedance converter according to claim 1, wherein
the predetermined multiple of the fundamental frequency is a threefold frequency of the fundamental frequency, and
the impedance value of the stub is five or more times larger than an impedance value of the characteristic impedance element on which the stub is formed.

5. The impedance converter according to claim 1, wherein
the impedance value of the characteristic impedance on which the stub is formed is equal to or smaller than 4Ω.

6. The impedance converter according to claim 4, wherein
a reflection coefficient F obtained based on a ratio of the impedance value of the stub which suppresses passage of a signal having the threefold frequency of the fundamental frequency to an impedance value at the fundamental frequency satisfies
Γ≧0.67.

7. The impedance converter according to claim 1, wherein
the at least one stub comprises a plurality of the stubs, and
the stubs have lengths corresponding to different predetermined multiples of the fundamental frequency.

8. The impedance converter according to claim 1, wherein
the at least one stub comprises a first stub formed on a side having a low impedance value of the characteristic impedance element on the signal input side and having a length which suppresses the passage of the signal having the predetermined multiple of the fundamental frequency, and
a second stub formed on a side having a high impedance value of the characteristic impedance element on the signal input side and having a length which suppresses passage of a low-frequency signal included in the signal having the predetermined multiple of the fundamental frequency.
